(19) United States
(12) Patent Application Publication
(10) Pub. No.: US 2006/0293898 A1
(43) Pub. Date: Dec. 28, 2006

(54) Speech recognition system for secure information

(75) Inventor: David G. Ollason, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/158,830

(22) Filed: Jun. 22, 2005

(51) Int. Cl. G10L 11/00

(52) U.S. Cl. 704/273

(57) ABSTRACT

A speech recognition system for secure information. Embodiments of the speech recognition system include a sub-word speech recognition component, which interfaces with a security system. The sub-word speech recognition component provides sub-word speech units for an input utterance, such as a password or security code. The sub-word speech units for the input utterance are provided to the security system for authentication.

### BACKGROUND

Many automated systems require a secure password or code to be entered using telephone keys to access information or to perform different functions. For example, automated banking systems may require a secure password or security code to retrieve account information. Such systems may prompt a user to input secret information, such as a birth date or social security number, or other password associated with the user. The system then verifies the user's input or response against a stored record of the secret information or password to verify the authenticity of the user. These simple numeric passwords are often relatively easy to discover, surreptitiously.

Different applications use phone or dialog systems to prompt a user to enter speech information as a response to the prompt, in order to perform tasks. These applications use speech recognition systems to recognize the input speech. Such speech recognition systems use grammars to identify words in a spoken utterance. In the context of a phone or dialog system for secure information, it is difficult to build a grammar for the secure data. This is because, for a grammar to recognize a word, it must have a rule written for that word. Thus, proper names and other words often used as secret password information are not well dealt with in grammars. Further, even if the grammar does contain the secret password, if the automated speech recognition takes place in the telephone dialog system, outside of a secure application or system, security is compromised because the secret password information is now generally unsecured.

Embodiments of the present invention address one or more of these and/or other problems. This background is not intended to limit the invention in any way, and is provided by way of example only.

### SUMMARY

Embodiments of the present invention relate to a speech recognition system for secure information. The speech recognition system includes a sub-word speech unit recognition component which interfaces with a security system. The sub-word speech unit recognition component receives a speech input utterance, representing a password or secret information, from a user, recognizes the sub-word speech units in the utterance and provides the sub-word speech units to the security system to compare the sub-word speech units against stored information or data.

The above summary is provided to introduce a selection of concepts in a simplified form that are further described in the Detailed Description section below. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one illustrative embodiment of a computing environment in which embodiments of the present invention can be used or implemented.

FIG. 2 is a block diagram of an illustrated embodiment of a speech recognition system for secure information.

FIG. 3 is a flow chart illustrating one embodiment of authentication of a user input utterance relative to secure information.

FIG. 4 is a block diagram illustrating an embodiment for entry of secure information in a security system.

FIG. 5 is a flow chart of an illustrated embodiment of steps for entry of secure information in a security system.

### DETAILED DESCRIPTION

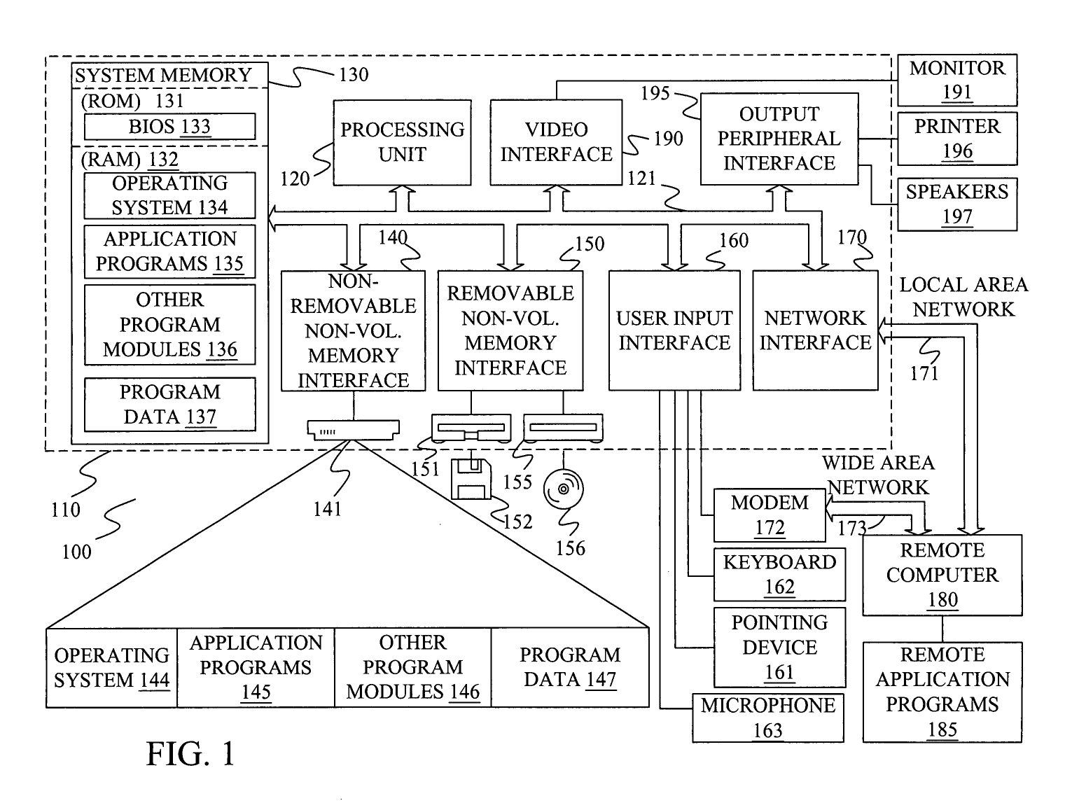

Embodiments of the present invention relate to sub-word speech recognition for secure information. Prior to describing the invention in more detail, an embodiment of on illustrative a computing environment 100 in which the invention can be implemented will be described with respect to FIG. 1.

The computing system environment 100 shown in FIG. 1 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement aspects of the present invention as instructions stored on computer readable media based on the description and figures provided herein.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

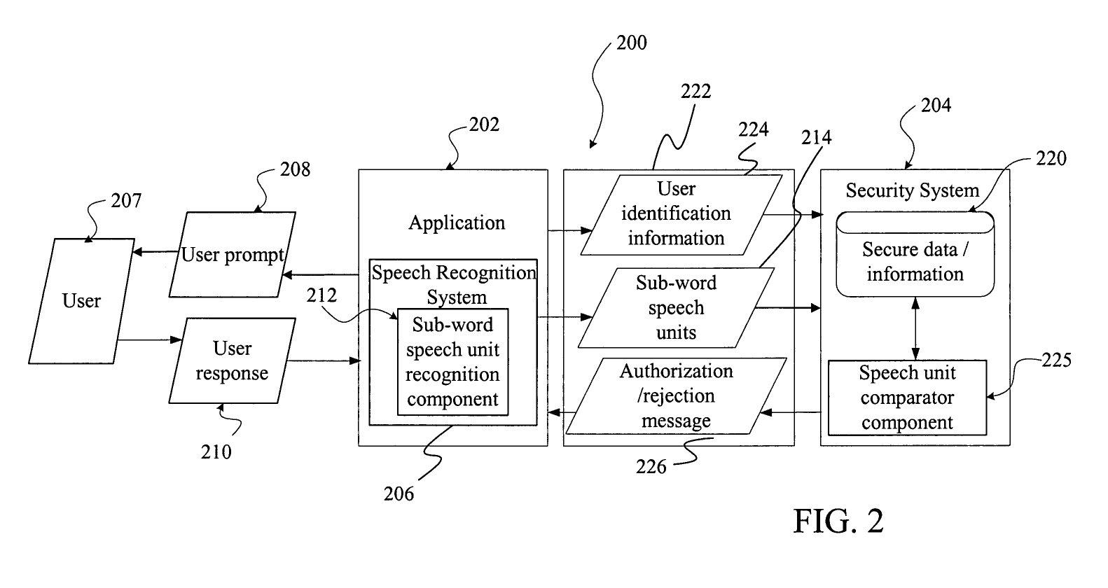

Embodiments of the present invention relate to a speech recognition system 200 for secure information which has varied applications and is not limited to the specific embodiments shown. In the embodiment shown in FIG. 2, the speech recognition system 200 includes application 202 and security system 204. In FIG. 2, application 202 is illustrating a telephone or dialog system that has a speech recognition system 206 that, in general, prompts a user 207 with audio prompts 208 and receives speech responses 210, and allows the user to perform certain tasks using voice commands and speech responses to prompts.

In one embodiment, speech recognition system 206 includes a sub-word speech unit recognition component 212. The sub-word speech unit recognition component 212 receives the response or utterance 210 from user 207. Component 212 recognizes, in the input speech utterance or response 210, sub-word speech units 214, such as phonemes.

In the embodiment shown, the security system 204 includes a secure database or secure information 220. In the embodiment described, the database 220 includes sub-word speech units corresponding to security data, such as passwords or security codes. As shown, the recognition component 212 interfaces with the security system 204 through a secure interface 222 for authentication of the input speech or utterance 210. Secure interface 222 illustratively is a firewall or other interface that employs a security protocol. The particular interface or protocol is not important for purposes of the present invention other than to say that the data in security system 204 is more secure than that in application 202.

In particular, in an illustrated embodiment, the system 200 is used to verify or authenticate a password or security code. The password or code is input by the user 207 in response to prompt 208. The utterance is processed into sub-word speech units 214 by the sub-word speech unit recognition component 212. The application 202 provides the sub-word speech units 214 in addition to a user identification 224, such as the user's name, account number or other identification code, to the security system 204.

The security system 204 uses the sub-word speech units 214 and user identification 224 to access stored information indicative of the password or security code corresponding to the received user identification 224. The stored information may be, for example, stored sub-word speech units. Sub-word speech units corresponding to the input speech are compared to stored data or stored sub-word speech units by a speech unit comparator component 225.

If the input sub-word speech units 214 match the stored password or security code then, an authorization message 226 is provided to application 202 through the secure interface 222 that the password is correct. Otherwise, the message 226 indicates that the password is not correct. As described, for the secure information, only sub-word speech units are recognized at application 202 and passed to the security system 204 over secure interface 222. Thus, word level recognition of secure information is not available outside of the security system 204 to protect the security of the information.

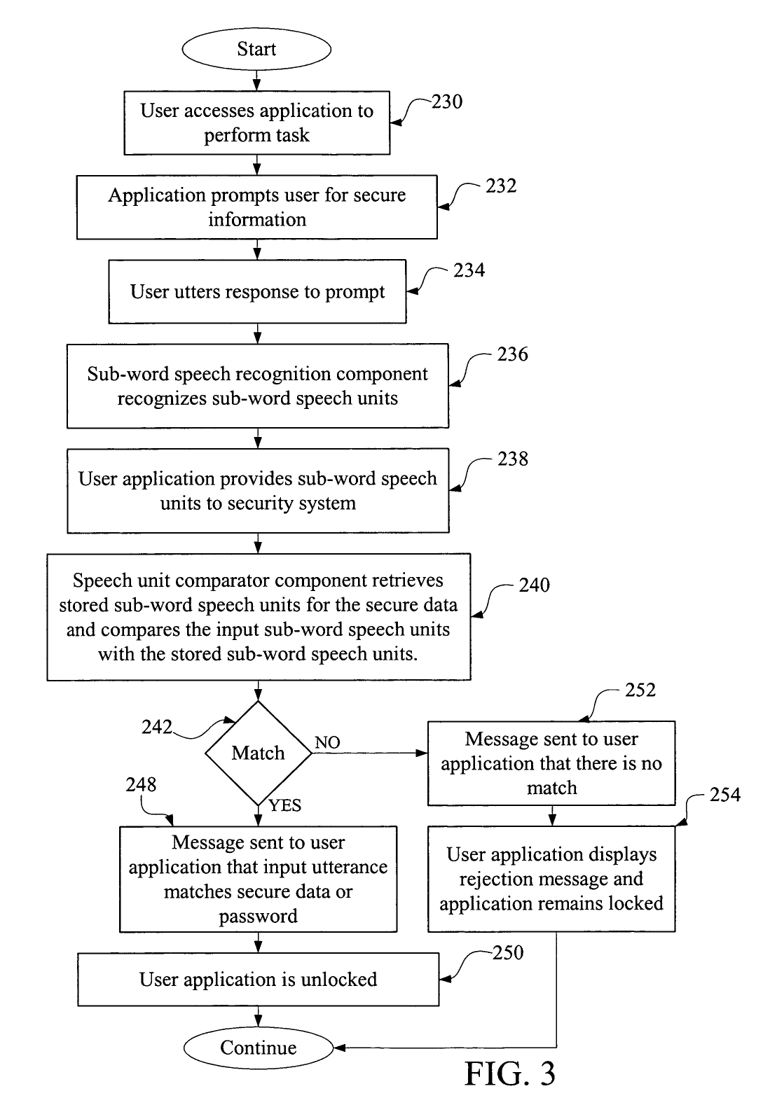

FIG. 3 illustrates in more detail steps for implementing a secure speech recognition embodiment for secure data such as a security code or password. In the illustrated embodiment, the user 207 accesses the application 202 to perform a task as shown in block 230 and the user 207 is prompted to enter secure information as illustrated by block 232, such as a password or security code.

In response to the prompt 208, the user 207 utters a response 210 as shown in block 234. The sub-word speech units in uttered response 210 are recognized by the sub-word speech unit recognition component 212 as illustrated by block 236. The sub-word speech units 214 are provided to the security system 204 through the secure interface 222 along with other identifying information 224 as illustrated by step 238. The security system 204 compares sub-word speech units 214 with secure data or information stored in store 220 for the identified user 207.

In particular, in the illustrated embodiment, speech unit comparator component 225 retrieves stored sub-word speech units for the secure data or information and compares the stored sub-word speech units to the input sub-word speech units 214 for the input utterance as illustrated by block 240. The stored sub-word speech units and the sub-word speech units for the input speech or utterance are compared to determine if the input utterance matches the stored data or password for the user 207 as illustrated by block 242.

If there is a match, then the security system or application 204 sends a message 226 to the application 202 verifying the match as shown in block 248 and the application 202 unlocks the task or information sought by user 207, as shown in block 250. For example, if the sub-word speech units for the input utterance match the sub-word speech units or phonemes for the stored information, the security system can unlock the application 202 so that the user can access otherwise locked information or perform a desired task or tasks.

If there is no match, then the security system 204 sends a message to the application 202 that there is no match as shown in block 252, and the application 202 remains locked and/or displays an error message to the user 207 as illustrated by block 254.

In the embodiments described, the secure information is never fully recognized outside of security system 204. Instead, only the sub-word speech units corresponding to the secure information are recognized and passed to the security system 204. Thus, word-level grammars for the secure information need not be available outside of the security system 204. For example, if the user is prompted to input the user's mother's maiden name to unlock a bank account of a telephonic banking system, the word level recognition is not available outside of the security system 204. Instead, the input utterance of the user's mother's maiden name is recognized as sub-word speech units, and the sub-word speech units are passed to the security system 204 to verify that the user's input utterance matches the data for the user's mother's maiden name stored in the secure database 220.

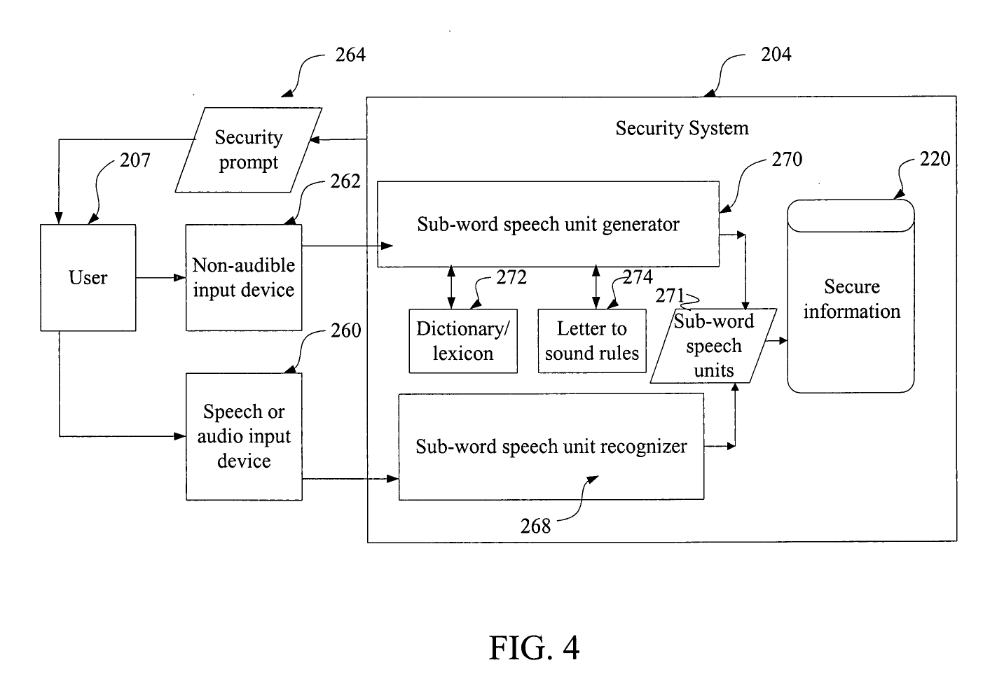

FIG. 4 illustrates an embodiment for registering with or enrolling in, system 200. The process involves inputting or creating sub-word speech units identifying the user's secure information for storage in the secure database 220. FIG. 4 shows an embodiment in which the user inputs the information directly into security system 204. However, it will be recognized that the secure information can be input through application 202 in system 200 in FIG. 2 as well. In the embodiment illustrated in FIG. 4, the secure information can be input to the security system 204 using a speech or audio input device 260 (such as a telephone or other voice dialog system) or alternatively using a non-audible input device 262 such as an alphanumeric keyboard or keypad. In the embodiment illustrated in FIG. 4, the security system 204 provides a security prompt 264 to the user 207 to enter secure information or data, such as for example, the user's mother's maiden name. In response to the security prompt 264, the user can provide an audio response or utterance or a non-audio response (such as a text response).

As illustrated in FIG. 4, if the user's input is by audio input device 260, the sub-word speech units in the audio response are recognized by a sub-word speech unit recognizer 268. If the user's response is entered via a non-audible input device 262 (such as in text), a sub-word speech unit generator 270 generates sub-word speech units for the text entry. For example, in the embodiment shown, sub-word speech units are phonemes, and are generated from text by the sub-word speech unit generator 270 using a dictionary or lexicon 272 to identify input words and letter to sound rules 274 to generate the phonemes for the recognized words. In either case, the sub-word speech units 271 from the sub-word speech unit generator 270 or sub-word speech recognizer 268 are stored in the secure database 220.

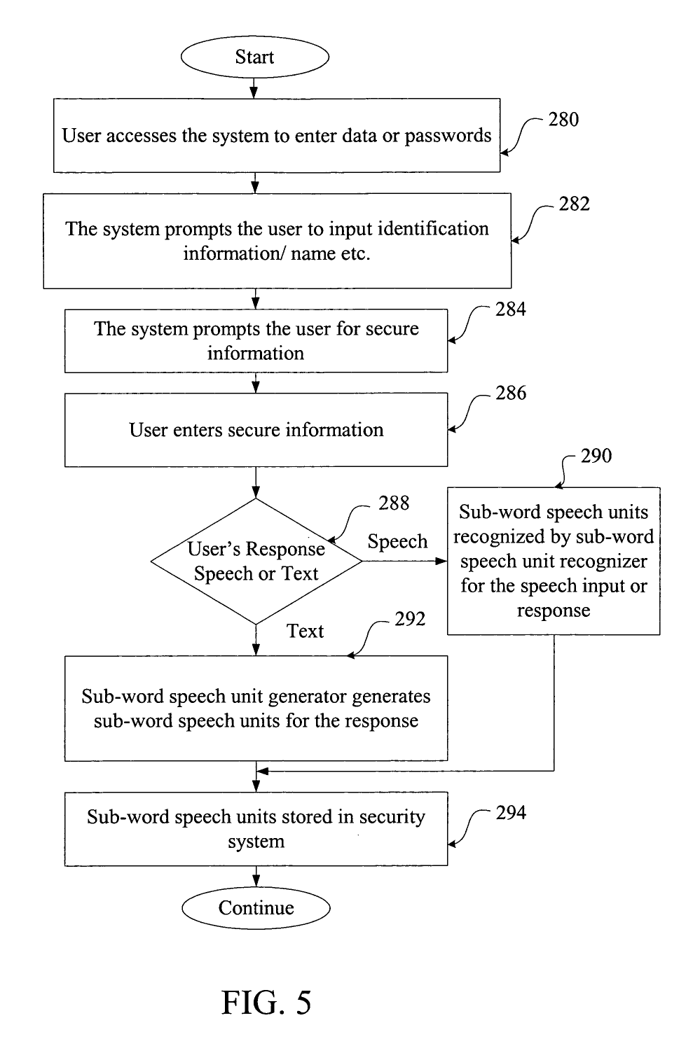

FIG. 5 illustrates steps, in more detail, for inputting secure information into the secure database 220. As shown, the user accesses the security system 204 as illustrated by block 280, and the user is prompted with prompt 264 to enter user identification information (e.g. name, telephone number, etc) to enroll, as shown in block 282. As illustrated by block 284, the user is also prompted to enter secure information (e.g. password or security code). The secure information is entered by the user through an audio input device 260 or non-audible input device 262 as illustrated by block 286.

As illustrated by block 288, the system determines if the user's response is non-audible (such as text) or speech. If the user's secure information is entered via the audio input device 260, sub-word speech units are recognized for the secure information entered by the user with the sub-word speech unit recognizer 268 as illustrated by block 290. If the user's response is entered as text input, sub-word speech units are generated for the text input or response by the sub-word speech unit generator 270 as illustrated by step 292. Once the sub-word speech units 271 are generated or recognized, the sub-word speech units 271 are stored in the secure database 220 under the user's identification or account, as illustrated by block 294.

Although the present invention has been described with reference to particular embodiments, workers skilled in the art will recognize that changes may be made in form and detail without departing from the spirit and scope of the invention.

What is claimed is:

1. A speech recognition system, comprising:
a sub-word speech unit recognition component configured to provide sub-word speech units for an input utterance representing security data; and
a security system, separate from the sub-word speech recognition component, configured to receive the sub-word speech units and to compare the sub-word speech units against stored information indicative of the security data.

2. The speech recognition system of claim 1 wherein the sub-word speech recognition component and the security system are coupled over a secure interface.

3. The speech recognition system of claim 1 wherein the security system is configured to retrieve stored sub-word speech units for the security data and compare the stored sub-word speech units to the sub-word speech units for the input utterance.

4. The speech recognition system of claim 1 wherein the security data includes passwords or security codes which are stored in a secure database.

5. The speech recognition system of claim 3 and further comprising:
an application operable with the sub-word speech unit recognition component and configured to provide a user identification to the security system and wherein the security system retrieves the stored sub-word speech units corresponding to the user identification.

6. The speech recognition system of claim 5 wherein the security system provides a message to the application based on a comparison of the stored sub-word speech units and the sub-word speech units for the input utterance that the security data is correct.

7. The speech recognition system of claim 6 wherein the application is unlocked in response to a match in the comparison.

8. An application, comprising:
a sub-word speech unit recognition component configured to recognize sub-word speech units corresponding to an input utterance, the application being configured to provide the sub-word speech units to a security system and receive security authorization from the security system based on the sub-word speech units.

9. The application of claim 8 wherein the application receives the input utterance in response to a prompt to enter security data and provides the input utterance to the sub-word speech unit recognition component to recognize the sub-word speech units.

10. The application of claim 8 wherein the application receives a user identification in response to a prompt and provides the user identification to the security system.

11. The application of claim 8 wherein the application is configured to be connected to the security system over a secure interface.

12. A method comprising the steps of:
receiving an input utterance;
recognizing sub-word speech units corresponding to the input utterance; and
providing the sub-word speech units to a security system through a secure interface to authenticate security information based on the sub-word speech units corresponding to the input utterance and stored sub-word speech units.

13. The method of claim 12 and further comprising:
providing a user identification to the security system; and
authenticating the security information based upon the sub-word speech units and the user identification.

14. The method of claim 13 wherein the input utterance is a security information input by a user and further comprising:
retrieving the stored sub-word speech units from a secure database based on the user identification; and
determining whether the sub-word speech units for the input utterance match the retrieved sub-word speech units for the user identification.

15. The method of claim 14 and further comprising:
unlocking a user application if the sub-word speech units for the input utterance match the stored sub-word speech units for the user identification.

16. The method of claim 12 and further comprising:
entering the security information in a secure database, along with a user identification;
providing sub-word speech units for the entered security information; and
storing the sub-word speech units in the secure database.

17. The method of claim 16 wherein the security information as input utterance is entered through an audio input device and the step of providing the sub-word speech units for the entered security information comprises:
recognizing in the input utterance sub-word speech units.

18. The method of claim 16 wherein the security information as a text input is entered through a text entry device and wherein providing the sub-word speech units for the entered security information comprises:
generating the sub-word speech units for the text input from the text entry device.
